(19) United States
(12) Patent Application Publication
(10) Pub. No.: US 2004/0126499 A1
(43) Pub. Date: Jul. 1, 2004

(54) Process and device for cold gas spraying

(75) Inventors: Peter Heinrich, Germering (DE); Heinrich Kreye, Hamburg (DE); Werner Krommer, Landshut (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: LINDE AKTIENGESELLSCHAFT, Wiesbaden (DE)

(21) Appl. No.: 10/453,870

(22) Filed: Jun. 4, 2003

(30) Foreign Application Priority Data
Jun. 4, 2002 (DE) 102 24 777.3

(51) Int. Cl. B05D 1/12; B05C 5/00; B05C 15/00; B05B 15/04; B05D 1/02

(52) U.S. Cl. 427/421; 427/180; 118/300; 118/326

(57) ABSTRACT

According to the invention, the carrier gas that accelerates the spray particles during cold gas spraying, or a component of the carrier gas, is captured, cleaned and collected after the cold gas spraying process. The cold gas spray gun (3) and the work piece (5) are located in a closed tank (4) from which the used carrier gas is removed, and advantageously the helium is recovered in a helium recovery unit (9). The invention enables use of optimally acting carrier gases, such as, for example, helium or helium-containing mixtures.

### CROSS-REFERENCE TO RELATED APPLICATION

This application is related to concurrently filed, commonly assigned application attorney docket no. LINDE-608 entitled “Process and Device for Cold Gas Spraying”, which corresponds to German priority 10224780.3, the inventors being Peter Heinrich, Heinrich Kreye, and Erich Muehlberger.

The invention relates to a process for producing a coating on a work piece or a molding in a cold gas spraying process, a carrier gas and powdered spray particles being released in a cold gas spray gun and the spray particles being brought to a speed sufficient to carry the particles, such as a speed of up to 2000 m/s.

It is known that coatings can be applied to materials of the most varied type by thermal spraying. Known processes for this purpose are, for example, flame spraying, arc spraying, plasma spraying or high-speed flame spraying. Recently, a process was developed, so-called cold gas spraying, in which the spray particles are accelerated to high speeds in a cold gas spray gun in a “cold” gas jet. The coating is formed by the impact of the particles with high kinetic energy on the work piece. Upon impact, the particles that do not melt in the “cold” gas jet form a dense and tightly adhering layer, plastic deformation and the resulting local release of heat providing for cohesion and adhesion of the spray layer to the work piece. Heating up the carrier gas jet heats the particles for better plastic deformation upon impact, and increases the gas flow velocity and thus also the particle speed. The associated gas temperature can be up to 800° C., but is distinctly below the melting point of the coating material, so that melting of the particles in the gas jet does not occur. Oxidation and/or phase transformations of the coating material can thus be largely avoided. The spray particles are added as powder by delivering the particles with an auxiliary gas flow to the main gas flow. The powder thus ordinarily comprises particles with a size from 1 to 50 μm. The spray particles acquire high kinetic energy as the gas is expanded. Generally, the gas after injection of the spray particles into the main gas jet is expanded in a nozzle, where the carrier gas and the spray particles are accelerated to speeds exceeding the speed of sound. Thus, for a particle, e.g., metal, there is a minimum velocity, for example, copper a velocity of 500-600 meters per second. With lower velocities, the copper can trickle down while higher velocities can result in copper sticking to the nozzle surface. Desirably, velocity should not only be sufficient to carry the particles but sufficient to bring the particles over the critical temperature when striking and deforming the target. Injection of the spray particles into the already accelerated main gas jet, however, is also practiced. One such process and a device for cold gas spraying are described in particular in European Patent EP 0 484 533 B1.

At least some of the parameters, e.g., temperature, of the present invention can be disclosed in Stoltenhoff, et. al., “An Analysis of the Cold Spray Process and its Coatings,” Volume 11(4), Journal of Thermal Spray Technology, December, 2002.

With respect to temperatures, generally temperatures lower than the melting point of the metal, but are as high as economically possible without baking the nozzle surface are desired. As an example, nickel has a melting point of 1550° C., so temperatures lower than 1550° C. are desired for nickel. More preferably, is using a temperature before the first effects of melting. So for nickel, a temperature of not more than about 0.5 to 0.6 of the melting temperature, e.g. 880 Kelvin would be desired because the particles remain un-molten in the gas stream. When the particles impact the target, the particles' surface rises and sticks to the targeted articles. Generally, higher temperatures of the gas permit higher nozzle velocities permitting better particle acceleration.

Temperatures can also vary depending on the gas used. As an example, helium allows operating at higher velocities and temperature as compared to nitrogen because there is less adhering of the particles to the nozzle surface. Generally, velocity of gas must be high so that the particles are heated over the crucial temperature (i.e., melting point), when striking the target, so that they stick and not fall down. Exemplary temperatures are 580° C. for copper, 680° C. for aluminum 600° C. for tantalum and 800° C for MCrAlY. With nitrogen as the carrier gas, particles can be accelerated to 1200 m/s, and in some instances, it maybe difficult to propel particles at sufficient speeds so they reach the critical temperature upon impact.

The carrier gases are generally nitrogen, helium and nitrogen-helium mixtures. The same gas or different gases can be used for the main and auxiliary gas flow. Nitrogen, the most frequently used carrier gas, is well suited as an inert and economical gas for the cold gas spraying process. Conversely, air, in spite of its high nitrogen content, is feasible only for a few applications due to the oxygen content. Generally, the highest particle speeds are reached with helium as the carrier gas. Because very large amounts of carrier gas are needed, however, generally in practice only nitrogen-helium mixtures with a low proportion of helium are used.

Economic considerations are decisive in the choice of the carrier gas due to extremely high carrier gas consumption. The consumption of carrier gas in cold gas spraying is between 40 and 150 m³/h. The gas consumption depends on the carrier gas used for the main and auxiliary gas flow and the material of the spray particles. Tests with helium as the carrier gas have shown that in order to spray 3 kg of spray material (for example MCrAlY), a bundle of 110 m³ of helium is necessary. In the choice of the carrier gas, consequently, economic aspects can be of priority importance; often they do not allow use of carrier gases that are optimum in terms of process engineering. (M is cobalt or nickel or an alloy of both.) Therefore, a feature of this invention is to devise a process that allows the choice of a carrier gas for the main and auxiliary gas flow that is optimum for the cold gas spraying process and improves the process of cold gas spraying.

This feature can be achieved according to the invention in that the carrier gas or a component of the carrier gas is captured, cleaned and collected after the cold gas spraying process. In order to be able to capture the carrier gas, cold gas spraying takes place advantageously in a closed vessel into which the carrier gas escapes during spraying. The used carrier gas is removed from this vessel and cleaned. Another possibility for capturing the used carrier gas is to spray it in an exhaust chamber and to send the exhaust gas to be cleaned. During cleaning at least, the free spray particles are removed from the carrier gas. Moreover, it is advantageous to remove from the carrier gas impurities that are introduced, for example, by mixing with air. Afterwards, the cleaned carrier gas is collected in a suitable tank. If only one component of the carrier gas is desired to be collected, the gas is cleaned not only of the gaseous impurities, but also the unwanted gas components are filtered out of the carrier gas. Only the desirable gas component reaches the collecting tank. The process according to the invention can make it possible to select the carrier gas according to its properties and not according to its economical availability, because the used carrier gas can be reused and does not escape into the environment, as in a conventional cold gas spraying process.

The cleaned carrier gas/gas component is advantageously returned to the cold gas spraying process; but it is also possible for the cleaned carrier gas/gas component to be sent to another application. The cleaning of the used carrier gas includes at least removal of free spray particles from the carrier gas. In general, however, first the free spray particles are removed from the carrier gas and afterwards the gaseous impurities are filtered out of the carrier gas before the cleaned carrier gas reaches the collecting tank for intermediate storage and is returned to the cold gas spraying process. If only one component of the carrier gas is to be reused, this component, after the free spray particles have been removed, is dissolved out of the carrier gas. The gas component is stored in the interim and finally returned to the cold gas spraying process.

The process according to the invention can be carried out in principle with all gases and gas mixtures as well as air. Possibility hydrogen may be used. Especially suitable gases are the rare gases, noble gases and inert gases and their mixtures. In particular, helium, argon and nitrogen and mixtures of these gases are used. Helium is contained especially advantageously in the carrier gas, preferably at least 20% by volume of helium, especially preferably between 30 and 80% by volume of helium. Two gases can be used in the process of the present invention. One gas is the process gas that imparts the high velocity and the other is the powder feed gas, which drives the powder into the process gas, and can be another gas or part of the process gas. After the powder is in the gas, it is the carrier gas. As an example, 10% of the gas as powder feeding gas can be cold and 90% of the gas as process gas can be hot. Mixtures of helium and nitrogen and of helium and argon have proven advantageous. Generally, very high particle speeds are reached with helium and helium-containing mixtures as the carrier gas. High spray particle speeds guarantee dense and adhesive coatings and thus high quality results in cold gas spraying. Due to the very high gas consumption in cold gas spraying and the high price of helium, the advantages of helium and helium-containing carrier gas in cold gas spraying can only be achieved with the process according to the invention.

In one advantageous embodiment of the process according to the invention, especially helium is recovered. To do this, removal of gaseous impurities from the used carrier gas takes place in a helium recovery unit that separates both the impurities and also the other components of the carrier gas from the helium. The helium that is recovered with high purity then reaches the collecting tank. Although helium recovery that works advantageously with membrane technology is very complex and expensive, recovery of the helium enables its use in cold gas spraying. Mainly in a large series it is possible to use helium with the process according to the invention, because the helium recovery expense is worthwhile.

In a further development of the invention, the cold gas spraying process is carried out at low pressure at values of below 800 mbar (80 kPa). This reduces the consumption of carrier gas and increases the spray particle speed. This increases the economic efficiency of the process according to the invention. This is advantageous especially when helium is contained in the carrier gas. Under vacuum conditions under which the spray process is carried out, the air resistance that slows down the spray particles emerging from the cold gas spray gun until reaching the sprayed article is very low. Consequently, the high spray particle speed that prevails when emerging from the spray gun is maintained until impact on the work piece occurs. As a result of the high particle speed, in turn the plastic energy of the particles is higher, and very dense and adhesive layers are formed. Also, the distance of the sprayed article from the spray gun can be chosen to be greater than under an air atmosphere because the spray particles are not slowed down by the air resistance on this route. This has the advantage that all geometries on moldings and work pieces can be coated. The use of a wide spray jet is also possible under low-pressure conditions, by which very high application rates are achieved.

In an advantageous embodiment of the invention, the pressure in the vacuum chamber is between 1 and 500 mbar (0.1 to 50 kPa), preferably 20 to 100 mbar (2 to 10 kPa). This pressure range can be achieved with commercial vacuum pumps.

In an advantageous further development, it becomes possible to use spray particles with a grain size of up to 160 microns. Larger spray particles must be accelerated so that their kinetic energy is enough to adhere the particles to the work piece to be coated.

To date, conventional spray particles have had grain sizes that range form 5-25 micron, partially also up to 50 micron, and they are generated accelerated near a nitrogen. Generally, small particles range up to 25 micron. If particles are too small, they cannot stick, but rather deflect with the gas. Portions of particles less than 5 microns should be less than 5% by weight of the total mass of particles.

With the process according to the invention, it now becomes possible to use helium or helium-containing gas mixtures as the carrier gas to a greater extent. With helium, much higher particles speeds are attained, by which larger spray particles with a grain size in the range from 80-150 micron are also accelerated relatively strongly, so that they adhere well to the work piece. Also, small particles of 25 microns, coarser particles 10-45 microns, or bigger particles 40-90 micron can be used with helium. Alternatively, particles 10-45 microns can be used with new or special nozzles with nitrogen. Generally, particles 40-90 microns are cheaper to use than smaller particles. Larger spray particles in turn have the advantage of smaller spray particles in that they cake less easily in the nozzle of the spray gun and clog it less. Because larger spray particles compared to smaller spray particles are more economical, the economic efficiency of the process according to the invention increases.

Types of particles include those that deform after splashing on target. Typically particles can be metallic powders, polymer powders, or composite powders where ceramic particles are inside. Specifically, exemplary particles are MCrAlY where M is a metal such as nickel, cobalt, or both, Cr is Chromium, Al is Aluminum and Y is yttrium. Other exemplary particles can include nickel, copper, aluminum, or tantalanium, or combinations thereof. Generally, it is desired to spray a metal particle on a ceramic article because shooting a ceramic particle on a ceramic article can result in only a first layer adhering to the article while the second or additional layers fail to stick to the article by, e.g., falling off. Also, particle filters selectively exclude particles that are too small, e.g., less than 1 micron and particles that are too big for adhering to the article. Particles too big fall off the article and fail to stick.

Alternatively, the spray gun (3) can be positioned partially outside the vacuum chamber, i.e., its outlet can be in the chamber and the particle/carrier gas inlets be outside the chamber.

A feature is achieved with respect to the device in that the cold gas spray gun and the work piece/molding that is to be coated are located in a closed tank. Thus, the carrier gas collects in the closed tank after the cold gas spraying process. The used carrier gas does not reach the environment, but is accessible to a cleaning and recovery process. The device according to the invention thus makes it possible to generally select the carrier gas according to technical criteria and not according to economic aspects.

The invention and other details of the invention are described in more detail below using one embodiment shown in the drawing.

### BRIEF DESCRIPTION OF THE DRAWINGS

FIG. 1 shows the cold gas-spraying device according to the invention.

FIG. 1 comprises a cold gas spray gun 3, a closed tank 4, a work piece 5, feed lines 1, 2, 6, 10 and 11, a particle filter 7 and a vacuum pump 8, as well as a recovery unit 9, an intermediate reservoir 12 and a mixer 13. The main gas flow, for example a helium-nitrogen mixture with 80% by volume of helium, travels via the gas feed line 1, and the spray particles in the auxiliary gas flow travel via the feed line 2 into the cold gas spray gun 3 that is located in the closed tank 4. The feed lines 1 and 2 are routed into the closed tank 4 for this purpose, in which both the cold gas spray gun 3 and also the work piece 5 are located. The entire cold gas spraying process thus takes place in the closed tank 4. The carrier gas, which sprays out of the spray gun 3 in cold gas spraying together with the spray particles and carries the spray particles to the work piece, is captured in the closed tank after the cold gas spraying process. From there, the used carrier gas is discharged with the vacuum pump 8 via the line 6. Upstream of the vacuum pump 8, the particle filter 7 is mounted, and it removes free spray particles from the used carrier gas. Generally, the particle filter 7 corresponds to the size of the particles. Alternatively, the filters can be used, namely one to clean dust from the gas and the other to hold back the particles. However, the dust filter carrier may plug quickly if larger particles can reach it. Following the vacuum pump 8, the carrier gas travels into the recovery unit 9. The recovery unit 9 that works with membrane technology separates the helium from the nitrogen and the impurities. Generally 50-100%, or 95-98% of the helium is recovered. Helium is obtained here with a purity of more than 99%. The impurities are discharged via the line 10 into the environment. The recycled helium travels via the line 11 into the intermediate reservoir 12 where it is collected before it is mixed with the other carrier components in the mixer 13 and is returned to the cold gas spraying process. A line 14 permits the addition of make-u[helium, such as fresh or pure helium.

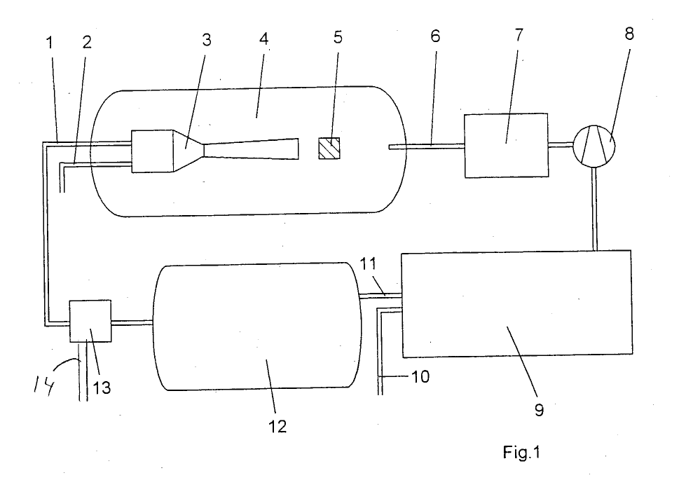

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosure of all applications, patents and publications, cited herein and of corresponding German Application No. 10224777.3, filed Jun. 4, 2002 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. In a process for producing a coating on a work piece or a molding in a cold gas spraying process, a carrier gas being released in a cold gas spray gun and applied to the work piece/molding, the improvement wherein the carrier gas or one component of the carrier gas is captured, cleaned and collected after the cold gas spraying process.

2. A process according to claim 1, wherein the carrier gas or the recovered component of the carrier gas is returned to the cold gas spraying process.

3. A process according to claim 1, wherein helium is contained in the carrier gas.

4. A process according to claim 3, wherein the helium in the carrier gas is recovered with a helium recovery unit.

5. A process according to claim 1, wherein the cold gas spraying process is carried out at low pressure at values below 800 mbar (80 kPa).

6. A process according to claim 5, wherein the cold gas spraying process is at a pressure of between 1 and 500 mbar (0.1 to 50 kPa).

7. A device for producing a coating on a work piece or a molding in a cold gas spraying process comprising a cold gas spray gun (3) and a work piece holder for the work piece/molding (5) to be coated, wherein the cold gas spray gun (3) and the work piece/molding (5) to be coated are located in a closed tank (4).

8. A process for spraying a coating on a object with a carrier gas entraining particles, comprising capturing, cleaning, and collecting at least one component of the carrier gas after spray coating an object.

9. A process according to claim 8, wherein the object is a work piece or a molding.

10. A process according to claim 8, wherein the carrier gas comprises helium.

11. A process according to claim 11, wherein the carrier gas comprises at least 20% by volume of helium.

12. A process according to claim 11, wherein the carrier gas comprises 30-80% by volume of helium.

13. A process according to claim 10, wherein the helium in the carrier gas is recovered with a helium recovery unit.

14. A process according to claim 8, wherein the cold gas spraying process is carried out at low pressure at values below 80 kPa.

15. A process according to claim 14, wherein the cold gas spraying process is at a pressure of 20-100 mbar (2-10 kPa).

16. An apparatus for spray coating an object comprising:
a closed tank; and
a cold gas spray gun and a work piece holder located in the closed tank.

17. An apparatus according to claim 16, further comprising a gas recovery unit located downstream of the tank.

18. An apparatus according to claim 17, further comprising an intermediate reservoir and a mixer located downstream of the gas recovery unit.

19. A process according to claim 8, wherein the carrier gas is sprayed at a velocity sufficient enough to carry the particles.

20. A process according to claim 5, wherein the pressure of the cold gas is between 1 and 500 m/bar.

21. A process according to claim 5, wherein the pressure of the cold gas is between 20 and 100 m/bar.

22. A process according to claim 1, wherein the grain size of the sprayed particles is up to 150 microns.
